(19) United States
(12) Patent Application Publication
(10) Pub. No.: US 2025/0274412 A1
(43) Pub. Date: Aug. 28, 2025

(54) SYSTEM AND METHOD FOR SWIPE-BASED CHAT INTERACTION AND CONTEXTUAL MESSAGE EDITING

(71) Applicant: Celligence International LLC, Guaynabo, PR (US)

(72) Inventors: Pavan AGARWAL, Dorado, PR (US); Gabriel Albors Sanchez, San Juan, PR (US); Jonathan Ortiz Rivera, San Juan, PR (US)

(73) Assignee: CELLIGENCE INTERNATIONAL LLC, Guaynabo, PR (US)

(21) Appl. No.: 19/208,196

(22) Filed: May 14, 2025

Related U.S. Application Data
(63) Continuation-in-part of application No. 18/135,703, filed on Apr. 17, 2023.
(60) Provisional application No. 63/332,205, filed on Apr. 18, 2022.

(51) Int. Cl. H04L 51/04; G06F 3/04817; G06F 3/04883

(52) U.S. Cl. CPC H04L 51/04; G06F 3/04817; G06F 3/04883

(57) ABSTRACT

Systems and methods are disclosed for enabling gesture-based controls within a conversational interface. The system interprets swipe gestures and dual-touch interactions to streamline chat-based workflows. A swipe-right gesture across a chat input field triggers predictive message autofill based on conversational history and user-specific context. A swipe-left gesture recalls the user's last-sent message and places the input field into an editable state. Additionally, emotional reactions may be applied to specific chat messages through dual-hand gestures, such as upward swipes or semicircular motions, which map to reactions including thumbs up, love, thumbs down, hate, happy, and sad. In domain-specific implementations, users may swipe across AI-recommended content—such as real estate listings—to indicate preferences, allowing the assistant to adapt future suggestions accordingly. These features enable low-friction, expressive interaction within mobile and web-based messaging environments.

### RELATED APPLICATIONS

This application a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### FIELD

The present disclosure relates generally to user interaction systems in conversational interfaces, and more particularly to systems and methods for enhancing chat-based communication through gesture-based input mechanisms. In particular, the disclosure pertains to swipe-based controls for automatically populating predicted responses and recalling prior messages for editing within a chat interface.

### BACKGROUND

Conversational interfaces, such as chatbots, messaging applications, and virtual assistants have become ubiquitous across mobile and web-based platforms. These interfaces often rely on traditional text input and button-based interactions, which may limit efficiency and ease of use, particularly on touchscreen devices.

While predictive response technologies have advanced, allowing AI to suggest or auto-complete replies, user engagement with such suggestions remains relatively manual. Similarly, editing previously sent messages typically requires multiple taps, navigating menus, or long-press actions that may not align with fast-paced, mobile-first communication.

Swipe gestures have become a widely accepted and intuitive form of user interaction, as seen in contexts such as email triage and social applications. However, their application to conversational AI and message editing workflows remains underdeveloped. Accordingly, there is a need for systems and methods that integrate gesture-based input, specifically swipe gestures, into messaging interfaces to facilitate seamless predictive responses and contextual message editing, thereby enhancing the fluidity and intuitiveness of chat-based communication.

### SUMMARY

In one aspect, the disclosure provides systems and methods for enhancing user interaction in a conversational interface through gesture-based controls. Rather than relying solely on typed input or buttons, the disclosed approach interprets swipe gestures to automate common messaging actions. A swipe-right gesture across a chat input field causes the system to retrieve and auto-fill a predicted message response. A swipe-left gesture retrieves the user's previously sent message and repopulates it into the input field in an edit mode, enabling streamlined correction workflows.

In another aspect, the system supports emotional tagging of individual chat messages using dual-hand gesture inputs. By anchoring the screen with one finger and performing a gesture with the other, the user may apply emotional reactions to message bubbles. Gestures such as a single swipe up, double swipe down, or semicircular motion are mapped to reactions including thumbs up, love, thumbs down, hate, happy, and sad. The selected reaction is displayed visually adjacent to the affected message.

In yet another aspect, the system supports domain-specific workflows, such as real estate browsing. When the AI Assistant presents property suggestions, the user may swipe right or left to indicate interest. These gestures update the user's preference profile in real time and influence the assistant's future property recommendations.

The system architecture includes modules for gesture recognition, message prediction, message recall, reaction mapping, and conversational state management. These features are optimized for mobile devices and touchscreens, offering an efficient and expressive alternative to traditional input models.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram of an exemplary system architecture for implementing swipe-based chat controls within a conversational interface, according to an implementation of the disclosure.

FIG. 2 is a flowchart illustrating gesture detection and conditional response logic for swipe-left and swipe-right interactions in a chat input field, according to an implementation of the disclosure.

FIGS. 3A-3C illustrate a user interface sequence in which a swipe-right gesture triggers predictive message autofill, according to an implementation of the disclosure.

FIGS. 4A-4C illustrate a user interface sequence in which a swipe-left gesture recalls a previously sent message for editing, according to an implementation of the disclosure.

FIGS. 5A-5M illustrate gesture-based emotional tagging of chat messages using dual-hand gestures, including swipe and semicircular motions, according to an implementation of the disclosure.

FIGS. 6A-6C illustrate a domain-specific real estate workflow in which swipe gestures are used to indicate property preferences and guide AI-generated suggestions, according to an implementation of the disclosure.

FIG. 7 illustrates an example computing system that may be used in implementing various features of embodiments of the disclosed technology.

Described herein are systems and methods for enabling gesture-based controls within a conversational interface. Rather than relying solely on typed input or static UI elements, the disclosed system interprets swipe gestures and touch-based interactions to streamline messaging workflows. Users may perform directional swipes to auto-fill predicted responses, recall prior messages for editing, or apply emotional reactions to specific chat entries. The system also supports domain-specific gesture applications—such as preference-based swiping in real estate contexts—to refine AI-driven recommendations in real time. Gesture detection and interpretation are handled dynamically during live conversation with an automated assistant (AA), ensuring fluid, mobile-optimized interaction. The architecture supports multimodal input, adaptive state transitions, and extensible gesture mapping across various conversational use cases. The following description sets forth several illustrative embodiments of the disclosed system, including modular architecture, messaging logic, and multi-device support. Other features and advantages will become apparent to those skilled in the art upon review of the specification, drawings, and claims. It is intended that all such systems, methods, features, and enhancements be considered within the scope of the present disclosure and protected by the accompanying claims.

### DETAILED DESCRIPTION

The disclosed system consists of a backend computing server and one or more client computing devices that facilitate gesture-based message interaction within a conversational interface. The system enables users to perform swipe gestures directly over a chat input field in order to trigger intelligent chat responses or modify previously sent messages. These gesture-based controls improve user efficiency and streamline conversational workflows by reducing reliance on manual typing or nested menu navigation.

Conventional messaging systems require users to manually type responses, rely on static quick-reply buttons, or engage in multiple taps to recall or edit prior messages. Such systems are not optimized for fluid mobile interactions and do not support intuitive, gesture-based shortcuts that enhance speed or reduce cognitive load. Moreover, conventional interfaces typically treat each message submission as final, offering no streamlined mechanism for post-submission edits within the conversational thread.

Furthermore, existing systems fail to utilize predictive text suggestions in conjunction with lightweight gestures, such as directional swipes, to minimize user input. Where editing is supported, it often requires navigating through message histories, long-press interactions, or accessing hidden menus—mechanisms that are both inefficient and inconsistent across devices. No known systems dynamically link simple swipe gestures with message recall, contextual editing, or intelligent response generation in a manner integrated with real-time chat interactions.

The systems and methods disclosed herein produce several technical effects and advantages over conventional chat interfaces. These include enabling gesture-based interactions (e.g., swipe-left and swipe-right) for chat input fields, dynamically invoking AI-based response prediction, and recalling prior messages in an editable state—all while preserving conversational context.

Additional advantages include: (i) reducing the number of taps or keystrokes required to reply or edit messages, (ii) offering touch-native controls consistent with mobile user behavior patterns, and (iii) distinguishing between newly composed messages and message edits using metadata flags for downstream message handling. Unlike static chat systems, the present system interprets user gestures as semantic actions, linking physical motion to dynamic conversational behavior.

The system also maintains a contextual chat state that allows for consistent user experiences across devices and sessions. When a swipe-left gesture recalls a prior message for editing, the system marks the chat input state as an “edit mode” and transmits the revised message with a designated indicator signaling it as an amendment rather than a new message. These enhancements provide a responsive and contextually aware communication environment that improves accuracy, efficiency, and user satisfaction.

The disclosed system includes several key components and modules that collectively enable gesture-based chat interaction. These components may reside on a user's computing device (e.g., smartphone, tablet) and/or communicate with a remote server for real-time processing and context preservation. The system may be implemented as part of a standalone chat application or embedded within a larger conversational interface platform.

Core components of the system may include, but are not limited to: (1) a gesture recognition engine, (2) a predictive response module, (3) a message history and recall module, (4) an input field state manager, and (5) a chat message transmission engine.

The gesture recognition engine is configured to detect directional swipe gestures over the chat input field. In some embodiments, the engine distinguishes between swipe-left and swipe-right gestures based on directional vectors, touch velocity, and gesture boundaries relative to the input field. Gesture input may be captured via native device APIs, custom UI event listeners, or hybrid interfaces, and may optionally support user-specific gesture calibration settings.

The predictive response module retrieves and ranks candidate responses based on conversation history, prior user selections, and contextual metadata (e.g., sentiment, intent, time of day). Upon detecting a swipe-right gesture, the system may auto-populate the input field with a selected predicted response, optionally offering the user an opportunity to confirm or modify the suggestion before transmission.

The message history and recall module manages previously sent messages by the user within an active chat session. When a swipe-left gesture is detected across the input field, this module retrieves the most recent user-submitted message (or a designated message, in some variants), re-inserts it into the input field, and designates the field as being in “edit mode.” The module ensures that the recalled message is editable and tracks user modifications for downstream logic.

The input field state manager tracks the status of the chat input field, including whether it is in a default composition state or edit mode. This component ensures that when a user modifies a recalled message and submits it, the message is flagged appropriately (e.g., with a metadata tag or payload annotation) to indicate that it is an edited message rather than a new submission. This enables backend systems to update previously transmitted messages in the chat log accordingly.

The chat message transmission engine packages and transmits the user's input—whether newly composed or edited—along with relevant metadata indicating message type, timestamp, and gesture-based input source (if applicable). This engine may also interface with delivery confirmation modules, edit tracking subsystems, or content moderation filters.

In some implementations, the system may further include optional components such as: gesture feedback module (e.g., haptic or visual cues), undo/redo control module for gesture actions, and device context module to calibrate gesture sensitivity based on screen size or input method. These components work together to deliver a seamless, intuitive, and responsive gesture-driven messaging experience optimized for conversational interfaces.

Upon receiving a swipe-right gesture across the chat input field, the system initiates a predictive response workflow. The gesture recognition engine identifies the swipe-right event and invokes the predictive response module. Based on the ongoing conversation context, user history, and available data signals, the module selects a likely user response—such as a simple affirmation (“yes”), negation (“no”), or context-specific phrase (“I live at 123 Main Street”).

The predicted response is automatically inserted into the chat input field, optionally accompanied by a visual indicator (e.g., ghost text, animation) or haptic feedback. The user may review, edit, or submit the suggested message. This swipe-to-autofill behavior reduces typing effort, improves response speed, and increases accessibility for users with limited input capacity.

A swipe-left gesture across the chat input field triggers message recall functionality. The gesture recognition engine processes the input and activates the message history module, which retrieves the most recent user-sent message from the current conversation thread. The recalled message is repopulated in the chat input field.

The input field state manager transitions the interface into “edit mode,” which may be visually distinguished (e.g., shaded input field, “Editing . . . ” label) and internally flagged for downstream systems. Any user-modified content submitted while in edit mode is transmitted with metadata indicating that the message is an edited version of a previously sent message, rather than a new entry.

This workflow enables seamless correction of typos, clarification of previously sent statements, or update of time-sensitive details—without requiring users to navigate history logs or issue separate edit commands.

Edited messages are associated with the original message identifier and transmitted with an edit indicator. The server may update the prior message inline in the chat interface or append the edited version, depending on configuration. Systems may optionally preserve both the original and edited messages in a versioned message log to support auditability, moderation, or rollback functionality.

In some embodiments, the system may restrict swipe-based edits to a configurable time window or allow recall of multiple previous messages through repeated left-swipe gestures. Additional safeguards may be imposed to prevent editing once messages have been acknowledged, forwarded, or archived, depending on business logic or compliance requirements.

The system may dynamically calibrate gesture sensitivity based on device characteristics (e.g., screen size, input resolution) and user preferences. For example, swipe thresholds may be adjusted to accommodate stylus input, left-handed users, or small screen devices. Visual or haptic feedback may confirm successful gesture recognition, improving user confidence and engagement.

In some implementations, the system may allow gesture-based undo of auto-filled or edited messages prior to submission, and may track gesture usage metrics to refine prediction accuracy or UI behavior over time.

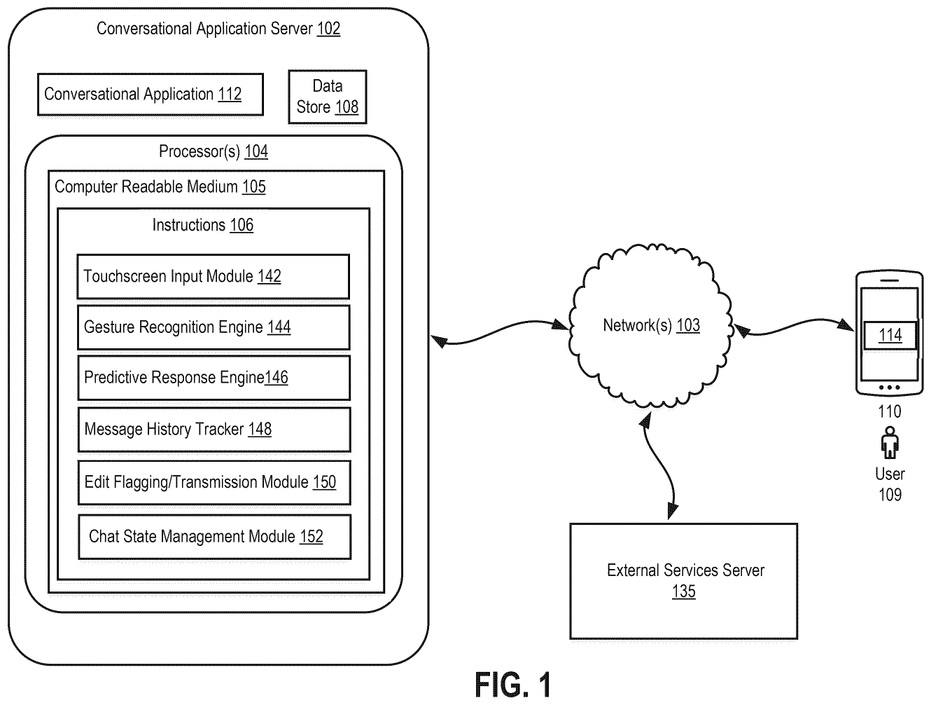

FIG. 1 illustrates an example system architecture for implementing swipe-based chat controls in a conversational interface. The system includes modules for gesture recognition, predictive response generation, message history tracking, input field state management, edit flagging, and chat session state handling. These modules collectively enable intuitive swipe gestures to trigger message autofill, recall prior messages, and manage conversational context with minimal user friction. The system includes a conversational application server 102, a user device 110, and optionally one or more external services servers 135, all interconnected via a network 103 (e.g., the Internet, a mobile network, or a secure enterprise network).

In the exemplary swipe-based chat interaction system 100, a user 109 engages with a conversational application server 102 using a client computing device 110 over one or more networks 103. The interaction may begin with a natural language message or user input provided through a web-based chat interface, mobile application, or other messaging interface supported by the client device 110. Unlike traditional systems that rely solely on typed text or button-based responses, the present system enables the user to perform gesture-based inputs, such as swipe-left or swipe-right gestures across the chat input field, to streamline communication. The conversational application server 102 executes a conversational application 112, using one or more processors 104 to execute instructions 106 stored in a computer-readable medium 105. These instructions include modules that detect gestures, predict responses, and manage conversational state. The system interprets swipe gestures in real time to trigger autofill of predicted replies or recall prior messages for editing—improving speed, fluidity, and user satisfaction.

The conversational application server 102 hosts the core backend logic for managing gesture-based messaging workflows. It includes one or more processors 104, a computer-readable medium 105 storing instructions 106, and an internal data store 108 for persisting session data, message histories, and user preferences. The server also executes a conversational application 112, which provides the primary interaction interface for user messaging.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

The instructions 106 include various functional modules that enable swipe-based input handling and dynamic chat behavior. These modules include a touchscreen input module 142, configured to detect and process user touch input events from connected devices; a gesture recognition engine 144, which interprets directional swipe gestures (e.g., left, right) performed over a chat input field; a predictive response engine 146, which generates candidate responses based on conversational history, user behavior, or contextual cues; a message history tracker 148, which maintains a record of previously submitted user messages and supports recall operations; an edit flagging/transmission module 150, which determines whether a submitted message constitutes an edit or a new message, and appends corresponding metadata; and a chat state management module 152, which manages conversational state, including edit mode flags, session continuity, and interaction context.

Client computing device 110 may be any computing device capable of interacting with the server, such as a smartphone, tablet, or wearable device. A user 109 interfaces with the device through a native or web-based chat interface 114, which displays the input field, receives gesture input, and transmits messages over the network 103. In some embodiments, the system communicates with external services servers 135, which may provide additional resources such as third-party APIs, identity validation, AI model hosting, or content moderation. These external services are optional and may be integrated depending on implementation needs.

The conversational interface enables the user to communicate naturally via typed input, while the system monitors for swipe gestures performed directly over the chat input field. These gestures are interpreted by the gesture recognition engine 144 and used to trigger context-specific chat actions—such as auto-filling a predicted response or recalling the last message for editing. The system ensures that these interactions occur seamlessly within the flow of conversation, without interrupting or requiring modal transitions. In some embodiments, swipe behavior may also influence the assistant's pacing, prompting additional suggestions or edit options as appropriate.

A conversational AI assistant (AA) guides the user throughout the interaction, hosted on server 102 and accessible via the client device 110. The assistant operates across various modalities, such as web chat, embedded interfaces, or partner applications. It supports real-time parsing of user input, classification of conversational context, and predictive modeling for likely replies. The assistant adapts its behavior based on message history, detected gesture usage, and prior corrections, allowing for more efficient and personalized engagement.

The assistant operates independently of any installed mobile application, enabling users to access full chat functionality—including gesture-triggered response prediction and message editing—through a browser or embedded environment. This flexibility allows users to engage from multiple devices or locations, with swipe-based input patterns recognized consistently across platforms. The assistant's interface remains lightweight, touch-friendly, and optimized for mobile interaction, further reducing friction in chat-based workflows.

In some embodiments, the conversational AI assistant is provided by the conversational application 112, executed by server 102. The assistant interacts with users through natural-language conversation and dynamically adjusts its prompts, suggestions, and input behavior based on chat context, swipe gestures, and user engagement. It supports workflows such as smart response suggestion, message recall and editing, and adaptive prompting—all while minimizing the need for manual typing or multi-step actions.

The AI assistant may be implemented as an integrated or third-party component operating on the server side. It processes user messages and gestures in real time, generating context-aware responses and suggestions. For example, upon detecting a swipe-right gesture, the assistant may suggest a reply tailored to the user's communication history. Upon a swipe-left, the assistant may infer that the user intends to correct their prior message and assist in reformatting or rephrasing it. Because the assistant operates remotely, no local installation is required on the client computing device 110.

The assistant continuously parses both natural-language inputs and gesture-based signals. It may use conversation history, interaction timing, and gesture patterns to refine predictions and guide conversation flow. In some implementations, the assistant adapts phrasing, tone, or specificity of suggestions depending on recent swipe behavior—e.g., offering shorter responses for users who frequently swipe right to autofill or offering clarification prompts after repeated edits.

In some embodiments, the assistant may also support multimodal interaction. For example, users may alternate between typed messages, swipe gestures, and voice input. Voice-to-text transcriptions may be displayed in the chat input field and may still respond to gesture events. Likewise, speech synthesis may be used to audibly confirm system actions following gesture detection (e.g., “Suggested message inserted” or “Editing previous message”).

The assistant monitors interaction cues such as gesture frequency, delayed responses, or message deletion behavior. In response, it may adjust its prompting strategy—for instance, reducing the number of suggestions if a user repeatedly swipes left to edit autofilled responses. These adaptive behaviors improve relevance and reduce frustration during high-speed or mobile messaging scenarios.

In some implementations, the assistant may proactively initiate micro-interactions based on predicted user intent. For example, if a conversation includes a scheduling query and the user pauses after receiving a suggestion, the assistant may surface a “Swipe right to confirm” prompt, streamlining intent fulfillment. These lightweight, context-driven micro-workflows reduce interaction friction.

If gesture behavior appears inconsistent or ambiguous—for example, if a user swipes back and forth repeatedly across the input field—the assistant may pause to request clarification or offer undo options. This ensures that gesture-driven actions remain intentional and user-controlled. In some configurations, repeated correction of suggested replies may cause the assistant to throttle predictions or adapt its language model weighting.

The AI assistant may also assist in guiding human assistants (HA) when escalation occurs. For example, if a user attempts multiple message edits in rapid succession or expresses confusion, the assistant may trigger escalation and pass along metadata about recent gestures, predictions, and message states. This enables the HA to seamlessly pick up the conversation with full visibility into the context of swipe-based interactions.

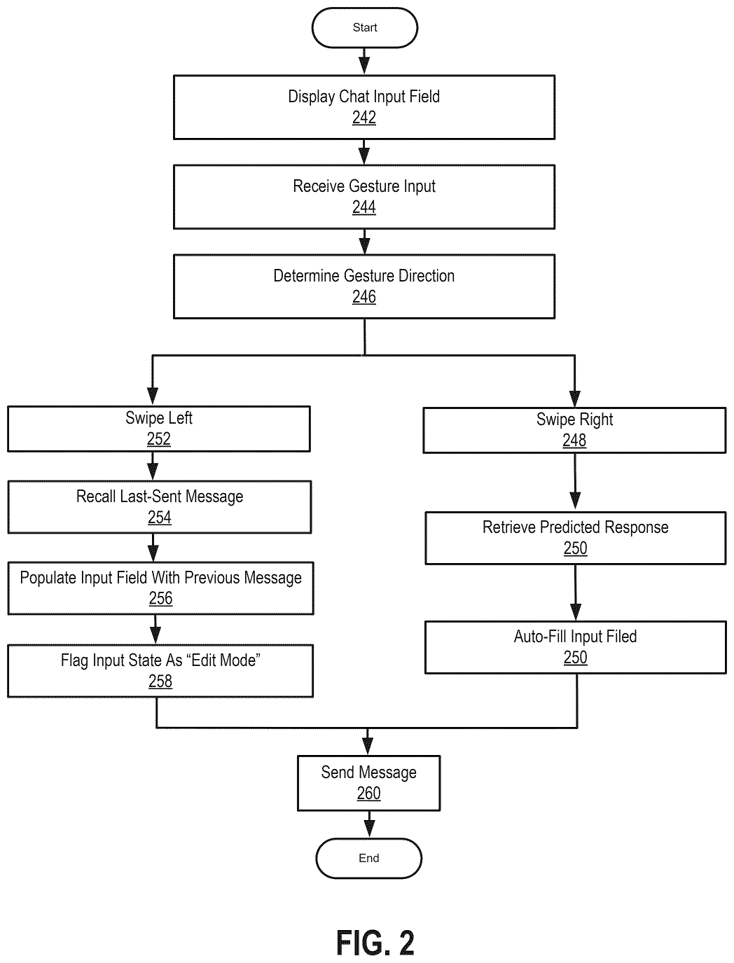

FIG. 2 illustrates an example gesture detection and message handling flow within a conversational interface. The process begins when the system displays a chat input field 242 on the user's device. The touchscreen input module 142 detects a gesture input 244 and the gesture recognition engine 144 determines the direction of the gesture 246. If the gesture is a swipe-right248, the predictive response engine 146 retrieves a contextually appropriate reply 250 and auto-fills the chat input field 250 with the predicted message. If the gesture is a swipe-left 252, the message history tracker 148 recalls the last-sent message 254, repopulates the input field with the previous message 256, and the input field state manager flags the input state as “edit mode” 258. In both cases, the final user message—either predicted or edited—is submitted via the chat message transmission engine 150, which sends the message 260 with appropriate metadata to indicate whether it is a new message or an edit. This flow supports intuitive swipe-based interaction, enabling quick replies and efficient corrections with minimal user effort.

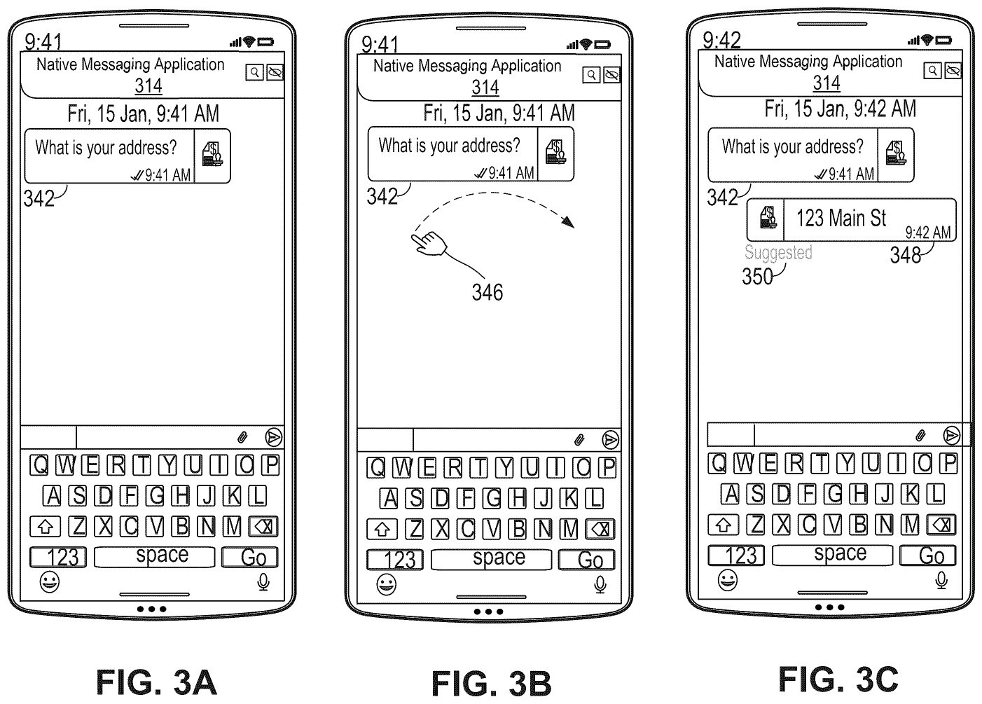

FIGS. 3A-3C illustrate an example user interface sequence in which a swipe-right gesture triggers a predictive response autofill within a native messaging application 314. In FIG. 3A, a prompt message 342 (“What is your address?”) is displayed in the conversation window, and the user's input field remains empty. In FIG. 3B, the user performs a swipe-right gesture 346 across the chat input field using a touchscreen interface. The gesture is detected by the gesture recognition engine 144 and interpreted as a request to retrieve a predicted response. In FIG. 3C, the predictive response engine 146 generates a suggested reply (“123 Main St.”), which is automatically inserted into the input field 348. A label 350, such as “Suggested,” may be displayed to indicate that the response was AI-generated and can be modified prior to submission. This swipe-right interaction enables the user to respond with minimal effort while preserving conversational flow and message context.

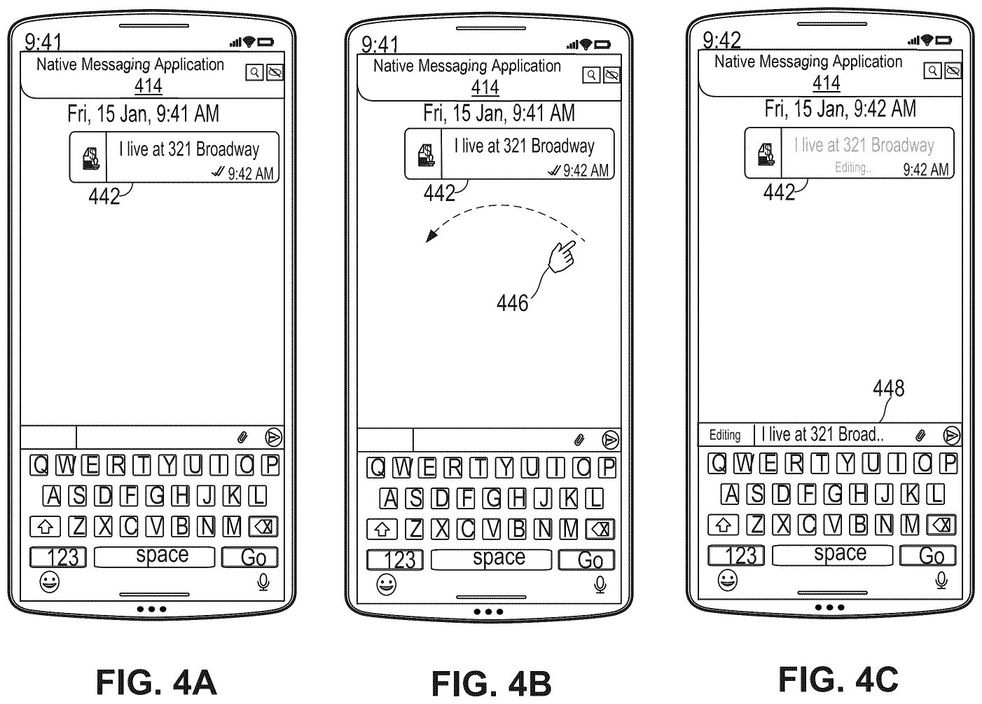

FIGS. 4A-4C illustrate an example user interface sequence for recalling and editing a previously sent message using a swipe-left gesture in a native messaging application 314. In FIG. 4A, a previously submitted user message 442 (“I live at 321 Broadway”) is displayed in the conversation window. In FIG. 4B, the user performs a swipe-left gesture 446 across the chat input area using a touchscreen interface. This gesture is detected by the touchscreen input module 142, e.g., illustrated in FIG. 1, and interpreted by the gesture recognition engine 144 as an intent to edit the most recent message. In FIG. 4C, the message 442 is retrieved from message history and repopulated into the input field 448. The input field is placed into an “Edit Mode,” as indicated by the editing label adjacent to or within the field. While in edit mode, the originally sent message 442 is visually grayed out or dimmed to signify that it is currently being modified, preventing user confusion and reinforcing Ul continuity. Upon submission, the modified message is transmitted along with metadata indicating it is an edited version of the original, rather than a newly composed message. This gesture-based editing workflow enables efficient, intuitive corrections in real time with minimal user friction.

In an additional embodiment, the system supports dual-hand gesture input for expressing emotional reactions to previously received or sent chat messages. To initiate an emotional tagging action, the user first places and holds one finger on the screen to anchor the message list and prevent scrolling. While holding the screen steady, the user uses a second finger—from the opposite hand or another finger on the same hand—to perform a gesture over the targeted message bubble.

The system interprets these dual-touch inputs as emotion-tagging gestures. The gesture recognition engine 144 is configured to detect the following mapped gestures and associate them with corresponding emotional responses. For example, single swipe up may indicate “Thumbs Up,” double swipe up may indicate “Love it”, single swipe down may indicate “Thumbs Down,” double swipe down may indicate “Hate it,” semicircle downward gesture may indicate “Sad,” semicircle upward gesture may indicate “Happy.”

Upon detecting a valid emotion-tagging gesture, the system displays an icon, emoji, or label adjacent to the targeted message to visually indicate the applied emotional reaction. These tags may be temporary or persistent, and in some embodiments, may also be stored as metadata associated with the message for analytical or display purposes across devices.

This dual-hand interaction technique prevents unintentional scrolls or misinterpreted gestures and allows expressive input in a fast, low-friction manner. The system may optionally support undo gestures, override logic for conflicting reactions, or gesture calibration based on user behavior.

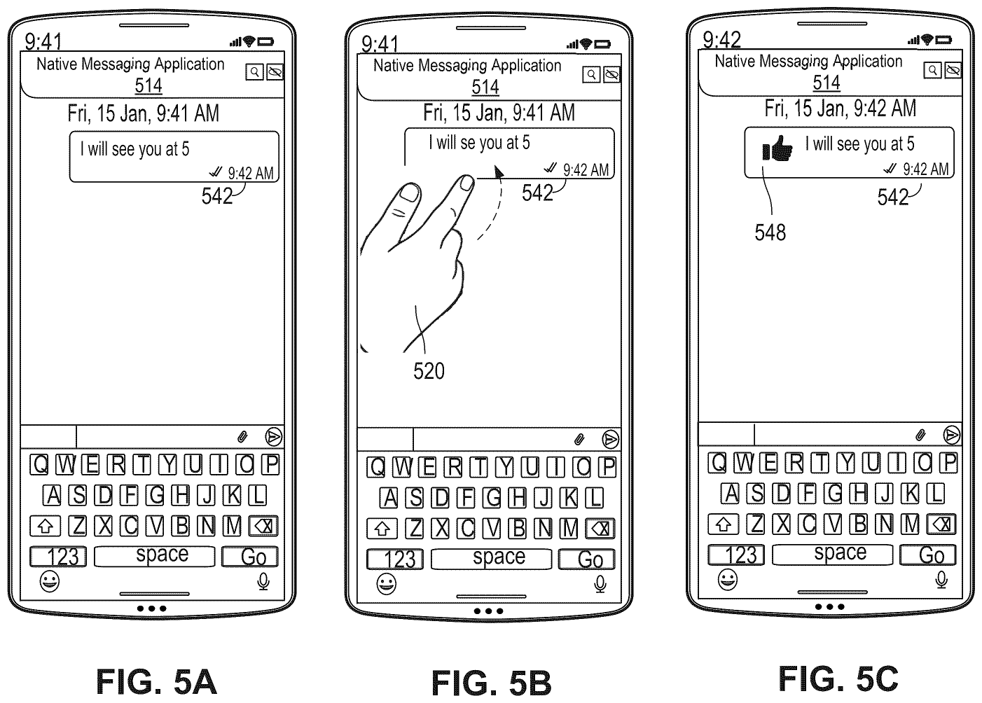

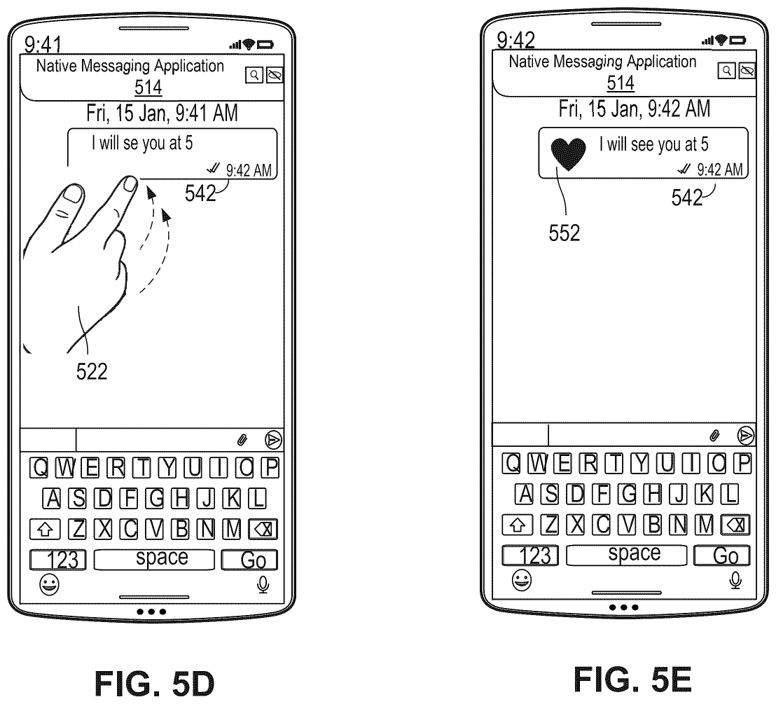

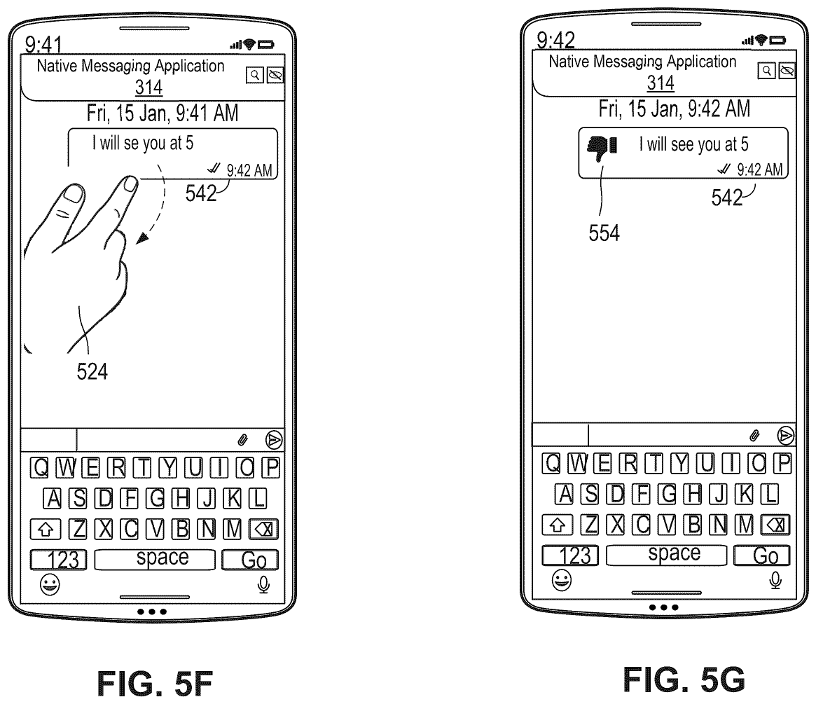

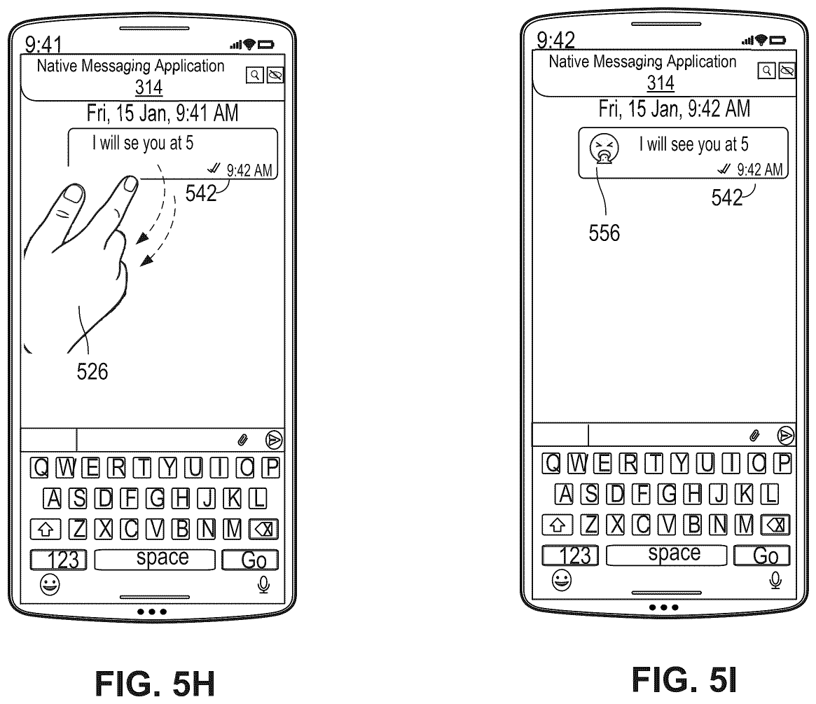

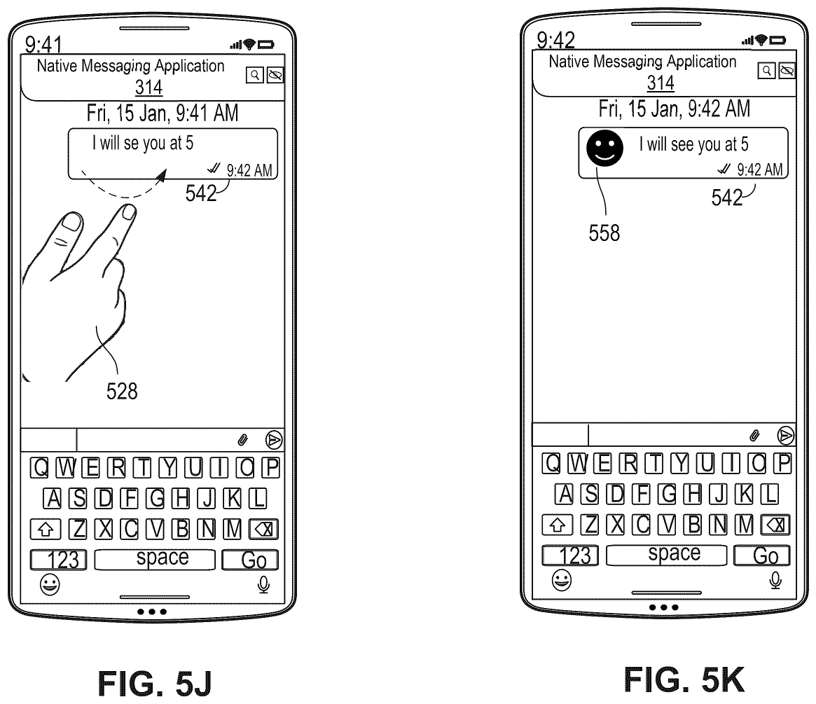

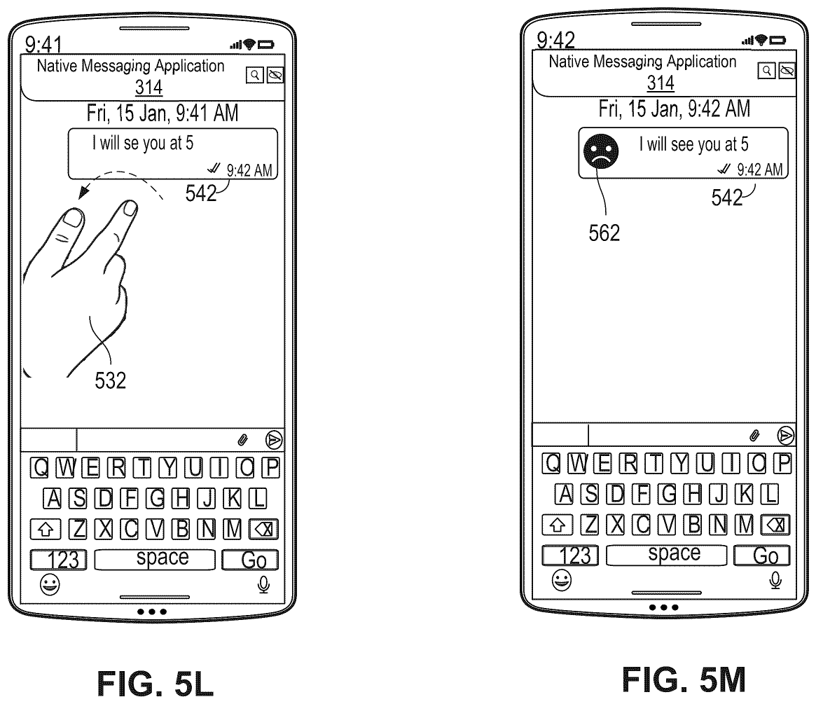

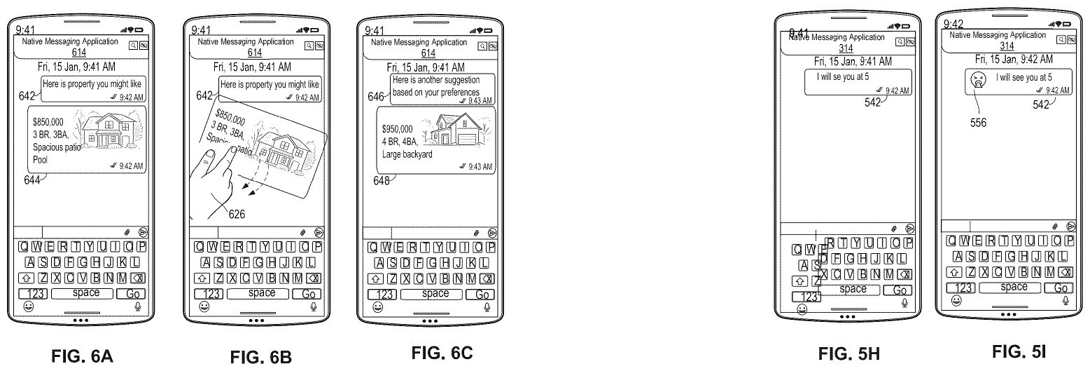

FIGS. 5A-5C illustrate a gesture-based emotional tagging interaction in which a user performs a single swipe-up gesture to express approval (“Thumbs Up”) on a message 542. In FIG. 5A, the user anchors the screen using one finger to prevent scrolling. In FIG. 5B, a second finger performs a single upward swipe 520 across the message. In FIG. 5C, the system displays a thumbs-up icon 548 adjacent to the message 542, indicating the reaction has been applied.

FIGS. 5D-5E show a double swipe-up gesture that applies a “Love it” reaction to the same message 542. In FIG. 5D, the user rapidly performs two upward swipe motions 522 while anchoring the screen. In FIG. 5E, the system displays a heart icon 552 to indicate that the message has been marked as strongly liked or emotionally significant.

FIGS. 5F-5G depict a single swipe-down gesture used to express a “Thumbs Down” reaction. In FIG. 5F, the user performs a single downward swipe 524 across the message while holding the screen. In FIG. 5G, the system renders a thumbs-down icon 554 adjacent to the original message 542.

FIGS. 5H-5I demonstrate a double swipe-down gesture, indicating strong disapproval or “Hate it.” In FIG. 5H, the user executes two rapid downward swipes 526. In FIG. 5I, a “barf” or disgust-style icon 556 appears alongside the message 542 to visually communicate the user's intense negative reaction.

FIGS. 5J-5K illustrate a semicircle upward gesture, representing a “Happy” emotion. In FIG. 5J, the user performs an arc-shaped upward swipe 528 across the screen. In FIG. 5K, the system displays a smiling emoji 558 linked to the message 542 to reflect the user's positive emotional state.

FIGS. 5L-5M depict a semicircle downward gesture, used to tag a message as “Sad.” In FIG. 5L, the user performs a curved downward swipe 532. In FIG. 5M, a sad face icon 562 is presented next to the message 542, providing an expressive, touch-native emotional response.

In a domain-specific embodiment tailored to real estate applications, the system enables swipe-based preference input for evaluating property suggestions. As the AI Assistant presents individual property listings within a conversational interface, the user may swipe right or swipe left on a visual property card or preview element. A swipe-right gesture is interpreted as a positive indication of interest (“like”), while a swipe-left gesture is interpreted as a negative response (“not interested”). This feedback is processed by the AI Assistant and used to dynamically refine the recommendation model in real time. For example, if the user repeatedly swipes right on beachfront properties with three bedrooms, the assistant will prioritize similar listings in future interactions.

This interaction model supports a “Tinder-like” discovery flow optimized for real estate browsing—reducing decision fatigue, improving personalization, and enabling high-volume property triage through natural, gesture-based controls. In some embodiments, the assistant may display visual confirmation of the swipe outcome (e.g., “Liked!” or “Skipped”) and update the recommendation strategy immediately within the session.

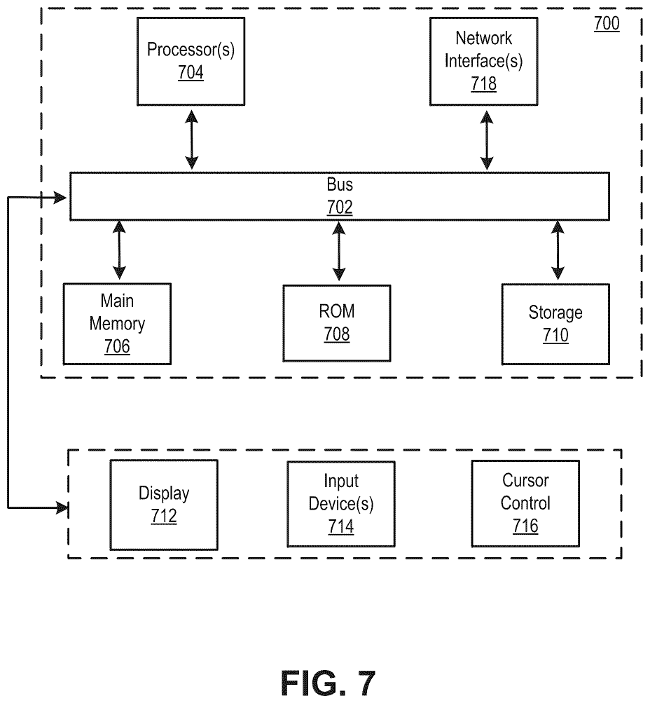

FIGS. 6A-6C illustrate an example interaction flow for swipe-based property preference selection in a real estate-specific implementation of the system. In FIG. 6A, the AI Assistant in a messaging application 614 presents a property suggestion 644 in response to a prompt message 642, which may include descriptive metadata such as price, bedroom/bathroom count, and features (e.g., patio, pool). In FIG. 6B, the user performs a swipe gesture 626 across the property card, indicating a like or dislike. The gesture is detected by the gesture recognition engine 144 and used to record a preference. In FIG. 6C, based on the swipe input, the system updates the user profile and presents a refined recommendation 648 accompanied by an updated assistant message 646. This interaction model allows users to quickly triage property listings through intuitive, mobile-native gestures and supports dynamic adaptation of search results based on swipe behavior.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 7. Various embodiments are described in terms of this example computing module 700. After reading this description, it will become apparent to a person skilled in the relevant art how to implement the technology using other logical circuits or architectures.

FIG. 7 illustrates an example computing module 700, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 700. After reading this description, it will become apparent to a person skilled in the relevant art how to implement the application using other computing modules or architectures.

Referring now to FIG. 7, computing module 700 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 700 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 700 might include, for example, one or more processors, controllers, control modules, or other processing devices, such as a processor 704. Processor 704 might be implemented using a general-purpose or special-purpose processing engine such as, for example, a microprocessor, controller, or other control logic. In the illustrated example, processor 704 is connected to a bus 702, although any communication medium can be used to facilitate interaction with other components of computing module 700 or to communicate externally. The bus 702 may also be connected to other components such as a display 712, input devices 55, or cursor control 716 to help facilitate interaction and communications between the processor and/or other components of the computing module 700.

Computing module 700 might also include one or more memory modules, simply referred to herein as main memory 706. For example, preferably random-access memory (RAM) or other dynamic memory might be used for storing information and instructions to be executed by processor 704. Main memory 706 might also be used for storing temporary variables or other intermediate information during execution of instructions to be executed by processor 704. Computing module 700 might likewise include a read only memory (“ROM”) 708 or other static storage device 710 coupled to bus 702 for storing static information and instructions for processor 704.

Computing module 700 might also include one or more various forms of information storage devices 710, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 710 might include other similar instrumentalities for allowing computer programs or other instructions or data to be loaded into computing module 700. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 700.

Computing module 700 might also include a communications interface or network interface(s) 718. Communications or network interface(s) interface 718 might be used to allow software and data to be transferred between computing module 700 and external devices. Examples of communications interface or network interface(s) 718 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 718 might typically be carried on signals, which can be electronic, electromagnetic (which includes optical) or other signals capable of being exchanged by a given communications interface. These signals might be provided to communications interface 718 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 706, ROM 708, and storage unit interface 710. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 700 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for enhancing user interaction within a conversational interface, the method comprising:
displaying, by a computing device, a chat input field in a graphical user interface;
detecting, via a touchscreen input, a swipe-right gesture across the chat input field;
in response to detecting the swipe-right gesture, retrieving a predicted response based on a prior conversation history and user-specific context;
auto-filling the chat input field with the predicted response;
detecting, via the touchscreen input, a swipe-left gesture across the chat input field;
in response to detecting the swipe-left gesture, retrieving a previously transmitted message associated with the user;
displaying the previously transmitted message in the chat input field;
flagging the chat input field as being in an edit mode; and
upon receiving a modified message input, transmitting the modified message along with an indicator that the message is an edit to the previously transmitted message.

2. The method of claim 1, further comprising detecting a held touch on the chat history region to prevent scrolling, and concurrently detecting a second touch performing a gesture associated with an emotional reaction on a message bubble.

3. The method of claim 2, wherein the emotional reaction is determined based on the gesture, the gesture comprising: a single swipe up for ‘thumbs up’, double swipe up for ‘love it’, single swipe down for ‘thumbs down’, double swipe down for ‘hate it’, semicircle down for ‘sad’, and semicircle up for ‘happy’.

4. The method of claim 2, further comprising displaying an icon or emoji adjacent to the message bubble corresponding to the identified emotional reaction.

5. The method of claim 1, further comprising presenting a property suggestion in a real estate application context and detecting a swipe-right or swipe-left gesture over a property card.

6. The method of claim 5, wherein a swipe-right indicates a positive preference and a swipe-left indicates a negative preference, and wherein subsequent property recommendations are adjusted based on the user's indicated preferences.

7. The method of claim 1, wherein the predictive response is selected from a ranked list based on natural language history and prior message frequency.

8. The method of claim 1, further comprising detecting a tap or text modification after a swipe-right to confirm or customize the predicted response before submission.

9. The method of claim 1, wherein the edit mode comprises a visual label displayed in proximity to the input field and disabling predictive autofill while in edit mode.

10. The method of claim 1, further comprising logging each gesture event with a corresponding message ID and timestamp for session continuity and audit tracking.

11. A system for gesture-based chat control comprising:
a user device with a touchscreen, a memory, and a processor;
a graphical user interface with a chat input field;
a gesture recognition module configured to detect swipe-left and swipe-right gestures across the chat input field;
a predictive response engine configured to retrieve and auto-fill predicted responses based on user context and chat history;
a message recall module configured to retrieve and populate a previously sent message upon detection of a swipe-left gesture; and
a transmission module configured to submit new or edited messages with corresponding metadata.

12. The system of claim 11, further comprising a dual-touch input handler configured to detect a held touch and a concurrent gesture for applying emotional reactions to chat messages.

13. The system of claim 12, further comprising an emotion mapping module that associates gestures with reactions including: thumbs up, love it, thumbs down, hate it, sad, and happy.

14. The system of claim 12, further comprising a rendering engine configured to display an icon adjacent to the message bubble upon recognition of an emotional gesture.

15. The system of claim 11, further comprising a domain-specific application interface configured to present property suggestions and detect like/dislike gestures on property cards.

16. The system of claim 15, wherein the interface updates a user preference model based on swipe feedback and generates new property recommendations accordingly.

17. The system of claim 11, wherein the gesture recognition module distinguishes between single, double, and semicircular gestures based on velocity and trajectory profiles.

18. The system of claim 11, further comprising an input state manager that labels the chat input field as being in edit mode and disables predictive suggestions while in that state.

19. The system of claim 11, wherein the transmission module appends a message status indicator identifying the submission as new or edited.

20. The system of claim 11, further comprising a session log that records each gesture input with a timestamp and message association for audit and context retention.
